(19) United States
(12) Patent Application Publication
(10) Pub. No.: US 2019/0006644 A1
(43) Pub. Date: Jan. 3, 2019

(54) BATTERY MODULE

(71) Applicant: HONDA MOTOR CO., LTD., Tokyo (JP)

(72) Inventor: Atsushi SAKURAI, Saitama (JP)

(73) Assignee: HONDA MOTOR CO., LTD., Tokyo (JP)

(21) Appl. No.: 15/987,038

(22) Filed: May 23, 2018

(30) Foreign Application Priority Data
Jun. 28, 2017 (JP) 2017-126435

(51) Int. Cl. H01M 2/10; H01M 2/30; B21C 23/14; B60L 11/18

(52) U.S. Cl. CPC H01M 2/1077; H01M 2/305; H01M 2220/20; B60L 11/1879; B21C 23/142

(57) ABSTRACT

A battery module includes: a cell stack body that is constituted by a plurality of cells stacked in a front-rear direction and includes a front surface, a rear surface, a left surface, a right surface, an upper surface, and a lower surface; and a casing that accommodates the cell stack body. In the battery module, the casing includes: a pair of end portions extending along the front surface and the rear surface of the cell stack body; and a side portions extending along the left surface and the right surface of the cell stack body. A width in the front-rear direction of the end portion is larger than a width in the left-right direction of the side portion.

### CROSS-REFERENCE TO RELATED APPLICATION(S)

This application claims priority from Japanese Patent Application No. 2017-126435 filed on Jun. 28, 2017, the entire contents of which are incorporated herein by reference.

### FIELD

The present invention relates to a battery module mounted on an electric vehicle.

### BACKGROUND

A battery module has been mounted on an electric vehicle or the like. For example, a battery module is disclosed in Japanese Patent No. 5405102 and JP-A-2012-256466 which are formed by a plurality of cells stacked in a front-rear direction and includes a cell stack body having a front surface, a rear surface, a left surface, a right surface, an upper surface, and a lower surface, a pair of end plates disposed on the front surface and the rear surface of the cell stack body, and a fastening frame for connecting the pair of end plates.

In this type of battery module, a load in a cell stacking direction of the battery module (hereinafter, appropriately referred to as a cell thickness constraint reaction force) occurs due to expansion of the cell caused by temperature change and aging deterioration. In recent years, since more active material is packed in the cell in accordance with the high capacity and the high energy density of the cell, the cell thickness constraint reaction force tends to increase.

The battery module disclosed in Japanese Patent No. 5405102 includes side frames (metal bands) disposed on the right surface and the left surface of the cell stack body, and the side frames respectively include side frame bodies and a front turn-around portion and a rear turn-around portion that turn around the front surface and the rear surface of the cell stack body (end plate) from the side frame body. In such a structure, since a load in a cell stacking direction due to expansion of the cell intensively acts on the front wraparound portion and the rear wraparound portion of the side frame, the front wraparound portion and the rear wraparound portion may be deformed in an opening direction, and movement of the end plate or dimensional variation of the battery module may occur.

In addition, the battery module disclosed in JP-A-2012-256466 includes side frames disposed on the right surface and the left surface of the cell stack body, and front and rear ends of the side frame are fastened to left and right side surfaces of the end plate with bolts. In such a structure, since a load in a cell stacking direction due to expansion of the cell is intensively applied to the bolt fastening portion, slipping may occur in the bolt fastening portion or the bolt may be deformed.

### SUMMARY

The present invention is to provide a battery module capable of receiving a load in a cell stacking direction due to expansion of cells while alleviating stress concentration.

The invention provides following aspects (1) to (11).

(1) A battery module (e.g., a battery module 1 in an embodiment to be described below) including:

a cell stack body (e.g., a cell stack body 2 in an embodiment) that is constituted by a plurality of cells (e.g., cells 21 in an embodiment) stacked in a front-rear direction and includes a front surface, a rear surface, a left surface, a right surface, an upper surface, and a lower surface; and

a casing (e.g., a casing 3 in an embodiment) that accommodates the cell stack body, wherein

the casing includes:
a pair of end portions e.g., end portions 31 in an embodiment) extending along the front surface and the rear surface of the cell stack body; and
a pair of side portions (e.g., side portions 32 in an embodiment) extending along the left surface and the right surface of the cell stack body, and

a width (e.g., a width W1 in an embodiment) in the front-rear direction of the end portion is larger than a width (e.g., a width W2 in an embodiment) in a left-right direction of the side portion.

(2) The battery module according to (1), wherein

the pair of side portions is connected to each other by a bridging portion (e.g., bridging portions 33 in an embodiment) extending in the left-right direction and an up-down direction.

(3) The battery module according to (2), wherein

a width (e.g., a width W5 in an embodiment) in the front-rear direction of the bridging portion is smaller than the width (e.g., the width W2 in an embodiment) in the left-right direction of the side portion.

(4) The battery module according to any one of (1) to (3), wherein

the pair of side portions each includes a projection (e.g., projections 32a in an embodiment) extending in an up-down direction between the cells adjacent to each other.

(5) The battery module according to any one of (1) to (4), wherein

the casing is an integrally molded product that is integrally formed.

(6) The battery: module according to (5), wherein the casing is made of aluminum, and is formed by extrusion molding.

(7) The battery module according to any one of (1) to (6), wherein

the cell stack body includes an external connection terminal (e.g., a terminal 23 in an embodiment), and

the external connection terminal is fixed to the end portion.

(8) A method of manufacturing a battery module (e.g., a battery module 1 in an embodiment to be described below), wherein

the battery module includes:
a cell stack body (e.g., a cell stack body 2 in an embodiment) that is constituted by a plurality of cells (e.g., cells 21 in an embodiment) stacked in a front-rear direction and includes a front surface, a rear surface, a left surface, a right surface, an upper surface, and a lower surface; and
a casing (e.g., a casing 3 in an embodiment) that accommodates the cell stack body,

the casing is an integrally molded product which is integrally formed of aluminum, and includes:
a pair of end portions (e.g., end portions 31 in an embodiment) extending along the front surface and the rear surface of the cell stack body; and
a pair of side portions (e.g., side portions 32 in an embodiment) extending along the left surface and the right surface of the cell stack body, and

the method comprises forming the casing through extrusion molding such that a width (e.g., a width W1 in an embodiment) in the front-rear direction of the end portion is larger than a width (e.g., a width W2 in an embodiment) in a left-right direction of the side portion in the extrusion molding.

(9) The method of manufacturing the battery module according to (8), wherein

the pair of side portions is connected to each other by a bridging portion (e.g., bridging portions 33 in an embodiment) extending in the left-right direction and an up-down direction, and

the bridging portion is also formed in the extrusion molding.

(10) The method of manufacturing the battery module according to any one of (9), wherein in the extrusion molding, a width (e.g., a width W5 in an embodiment) in the front-rear direction of the bridging portion is formed to be smaller than the width (e.g., the width W2 in an embodiment) in the left-right direction of the side portion.

(11) The method of manufacturing the battery module according to any one of (8) (10), wherein

the pair of side portions each includes a projection (e.g., projections 32a in an embodiment) extending in the up-down direction between the cells adjacent to each other, and

the projection is also formed in the extrusion molding.

According to (1), since the casing surrounding the circumference of the cell stack body receives the load in the cell stacking direction due to the expansion of the cell, the stress concentration can be alleviated.

In addition, since the width in the front-rear direction of the end portion, that is, the thickness of the end portion is larger than the width in the left-right direction of the side portion, that is, the thickness of the side portion, even when the load in the cell stacking direction increases, the end portion can receive the load.

Further, since the thickness of the side portion is thinner than the thickness of the end portion, the size and weight of the battery module can be reduced.

According to (2), since the pair of end portions is connected to each other by the bridging portion extending in the left-right direction and the up-down direction, the rigidity of the side portion and the entire casing is enhanced.

According to (3), since the width in the front-rear direction of the bridging portion is smaller than the width in the left-right direction of the side portion, it is possible to optimize the thickness of the respective portions according to the applied load, thereby achieving reduction in size, reduction in weight, and cost reduction of the casing.

According to (4), since the pair of side portions each includes a projection extending in the up-down direction between the cells adjacent to each other, vibration in the front-rear direction of the cell can be prevented.

According to (5), since the casing is an integrally molded product that is integrally formed, not only a process of assembling the casing is not necessary, but also the stress concentration in the casing can be alleviated.

According to (6), since the casing is made of aluminum and is formed by extrusion molding, not only the casing can be easily manufactured, but also the weight of the casing can be reduced.

According to (7), since the external connection terminal of the cell stack body is fixed to the end portion where the movement relative to the cell stack body is regulated, the distance variation between the terminal of the cell and the external connection terminal can also be regulated.

According to (8), since the casing is formed by the extrusion molding, the casing can be easily manufactured.

In addition, since the casing surrounding the circumference of the cell stack body receives the load in the cell stacking direction due to the expansion of the cell, the stress concentration can be alleviated.

In addition, since the width in the front-rear direction of the end portion, that is, the thickness of the end portion is larger than the width in the left-right direction of the side portion, that is, the thickness of the side portion, even when the load in the cell stacking direction increases, the end portion can receive the load.

Further, since the thickness of the side portion is thinner than the thickness of the end portion, the size and weight of the battery module can be reduced.

According to (9), since the pair of side portions is connected to each other by the bridging portion extending in the left-right direction and the up-down direction and the bridging portion is also formed in the extrusion molding, the rigidity of the side portion and the entire casing is enhanced without increasing the number of manufacturing steps.

According to (10), since, in the extrusion molding, the width in the front-rear direction of the bridging portion is formed to be smaller than the width in the left-right direction of the side portion, it is possible to optimize the thickness of the respective portions according to the applied load, thereby achieving reduction in size, reduction in weight, and cost reduction of the casing without increasing the number of manufacturing steps.

According to (11), since the pair of side portions each includes a projection extending in the up-down direction between the cells adjacent to each other and the projection is also formed in the extrusion molding, it is possible to prevent vibration in the front-rear direction of the cell without increasing the number of manufacturing steps.

### BRIEF DESCRIPTION OF DRAWINGS

FIG. 1 is a perspective view of a battery module according to a first embodiment of the present invention as viewed obliquely from above.

FIG. 2 is an exploded perspective view of the battery module according to the first embodiment of the present invention as viewed obliquely from above.

FIG. 3 is a perspective view illustrating a casing of the battery module according to the first embodiment of the present invention.

FIG. 4 is a plan view illustrating a main part of the battery module according to the first embodiment of the present invention.

FIG. 5 is a perspective view illustrating a casing of a battery module according to a second embodiment of the present invention.

FIG. 6 is a plan view illustrating a main part of a battery module according to a third embodiment of the present invention.

### DETAILED DESCRIPTION

Battery modules according to embodiments of the present invention will be described with reference to the accompanying drawings. It is noted that the drawings are to be viewed in directions of reference numerals.

### First Embodiment

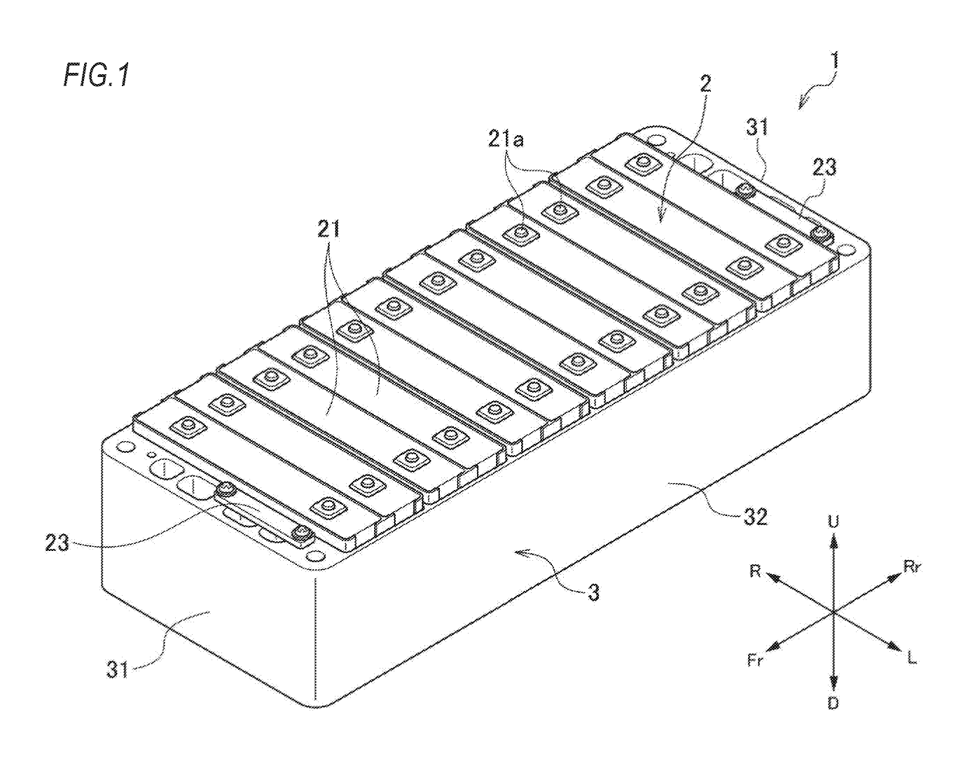

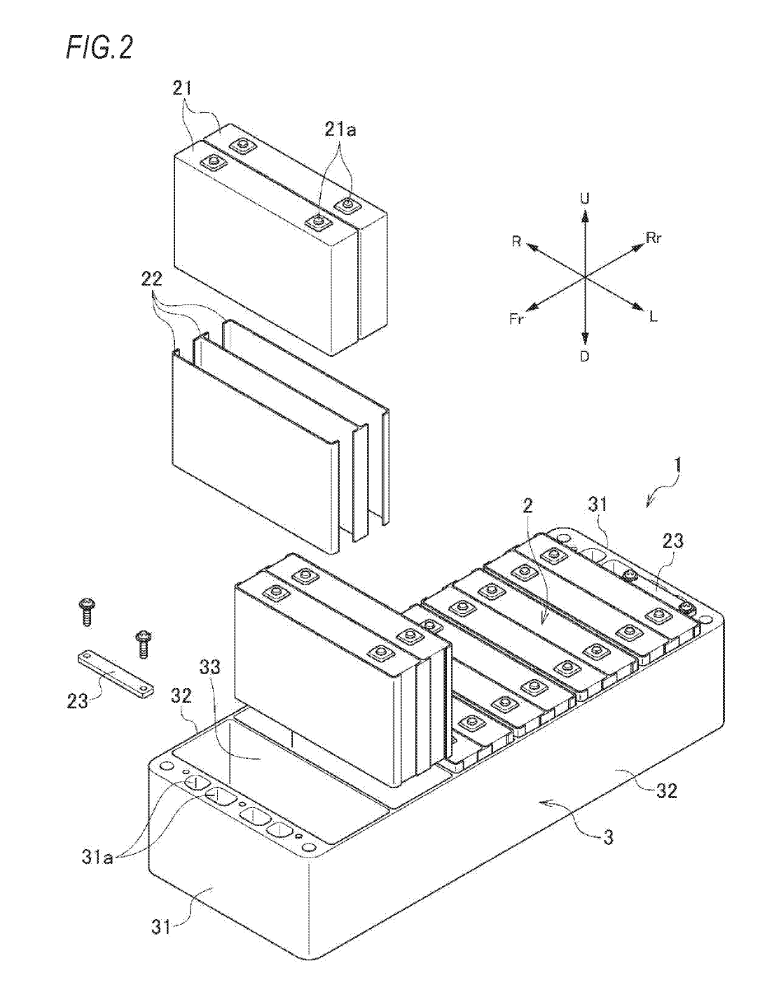

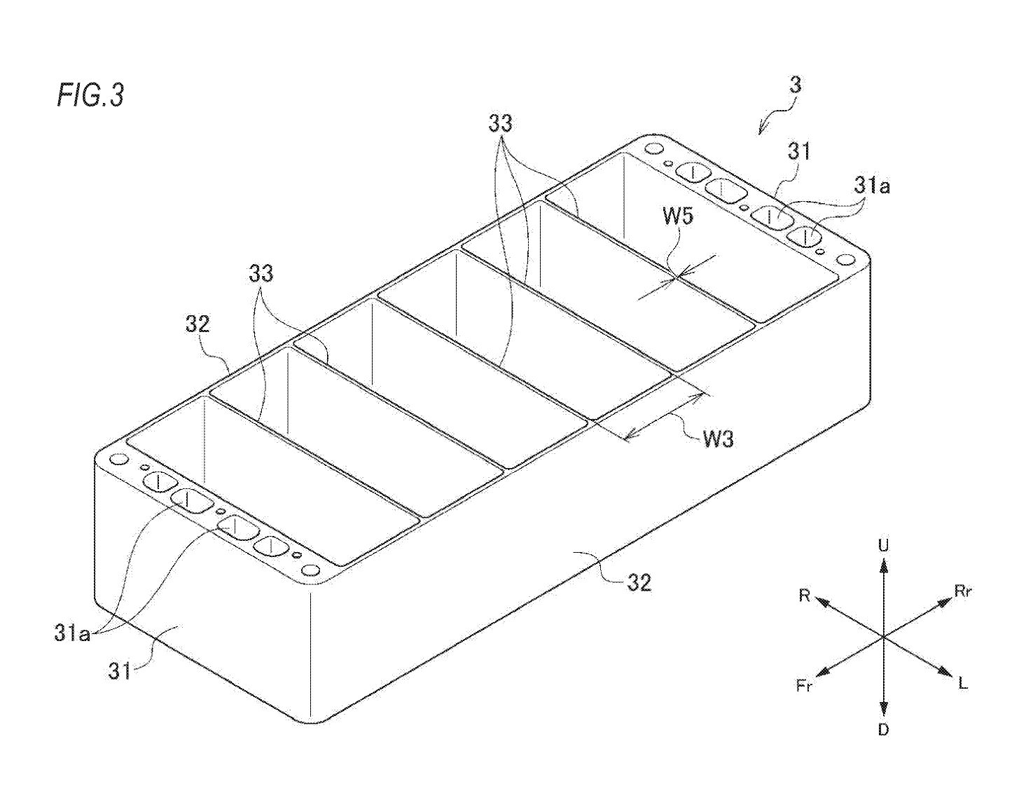

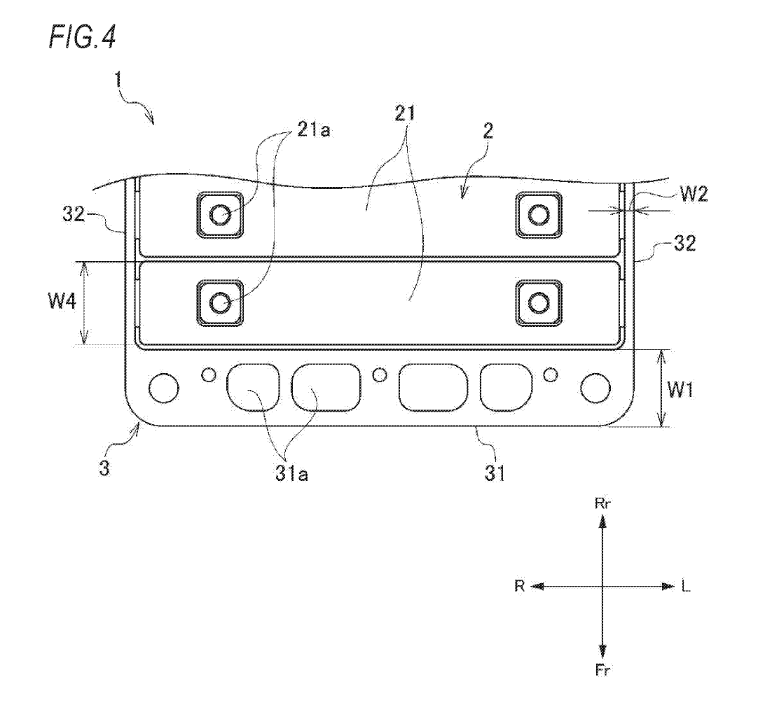

As illustrated in FIGS. 1 to 4, a battery module 1 according to a first embodiment of the present invention is constituted by a cell stack body 2 in which a plurality of cells 21 are stacked in a front-rear direction, and which includes a front surface, a rear surface, a left surface, a right surface, an upper surface, and a lower surface, and a casing that accommodates the cell stack body 2.

For the simple and clear description in this specification, a stacking direction of the cells 21 is defined as a front-rear direction, a direction orthogonal to the stacking direction of the cells 21 is defined as a left-right direction and an up-down direction, and the stacking direction is irrelevant to a front-rear direction or the like of products on which a battery module 1 is mounted. That is, when the battery module 1 is mounted on a vehicle, the stacking direction of the cells 21 may be aligned with a. front-rear direction of the vehicle, may be an up-down direction and a left-right direction of the vehicle, or may be inclined with respect to these directions. In the drawings, a front side, a rear side, a left side, a right side, an upper side, and a lower side of the battery module 1 are indicated by Fr, Rr, L, R, U, and D, respectively.

### (Cell Stack Body)

The cell stack body 2 is formed by a plurality of cells 21 and a plurality of insulation member 22 which are alternately stacked in the front-rear direction, and is accommodated in the casing 3 in an insulation state.

It is known that the cell 21 expands due to temperature change or aging deterioration. The cell 21 has a rectangular parallelepiped shape in which a length in the up-down direction is longer than a length in the front-rear direction and a length in the left-right direction is longer than a length in the up-down direction. Therefore, the front surface and the rear surface of the cell 21 have a much larger area than the left surface, the right surface, the upper surface, and the lower surface, and the front surface and the rear surface of the cell 21 easily expand at a central part in the left-right direction and a central part in the up-down direction thereof.

A plurality of busbars (not illustrated) are disposed on the upper surface of the cell stack body 2 to be electrically connected to terminals 21a of the cells 2. As the busbars, there are busbars for connecting the terminals 21a of the cells 21 with each other or busbars for connecting the terminals 21a of the cells 21 with external connection terminals (not illustrated), When the position of the terminal 21a of the cell 21 and the external connection terminal 23 are relatively changed, connection failure may occur. Therefore, it is necessary to fix the external connection terminal 23 at a position where the position of the external connection terminal relative to the terminal 21a of the cell 21 does not change. In the present embodiment, the external connection terminal 23 is fixed to the casing 3, and relative positional variation between the casing 3 (external connection terminal 23) and the cell stack body 2 (terminal 21a) is prevented based on a casing structure to be described below.

### (Casing)

The casing 3 includes a pair of end portions 31 extending along the front and rear surfaces of the cell stack body 2 and a pair of side portions 32 extending along the left and right surfaces of the cell stack body 2. That is, since the casing 3 receives a load in a cell stacking direction (hereinafter, also referred to as a cell thickness constraint reaction force as appropriate) of the cell stack body 2 while surrounding four circumferences of the cell stack body 2, stress concentration is alleviated.

The pair of end portions 31 is respectively brought into contact with the front surface and the rear surface of the cell stack body 2 through the insulation member 22. Therefore, the load in the cell stacking direction of the cell stack body 2 is directly applied to the pair of end portions 31 and is indirectly applied to the pair of side portions 32 connecting the pair of end portions 31,

A width W1 in the front-rear direction of the end portion 31, that is, a thickness of the end portion 31 is larger than a width W2 in the left-right direction of the side portion 32, that is, a thickness of the side portion 32. Thus, the end portion 31 is given higher rigidity than the side portion 32, and can receive the load in the cell stacking direction of the cell stack body 2 without movement. Therefore, the external connection terminal 23 is fixed to the end portion 31. In addition, since the thickness of the side portion 32, which does not require higher rigidity than the end portion 31, thinner than the thickness of the end portion 31, the size and weight of the battery module 1 can be reduced.

In addition, the end portion 31 is provided with a plurality of hollow portion 31a extending in the up-down direction, which makes it possible to reduce the weight of the battery module I and to absorb the external impact in the cell stacking direction at the end portion 31 including the hollow portion 31a.

The pair of end portions 32 is connected to each other by bridging portions 33 extending in the left-right direction and the up-down direction. In the present embodiment, a plurality of bridging portions 33 (for example, five bridging portions) are provided with predetermined distances W3 in the front-rear direction. Thus, the rigidity of the side portion 32 and the entire casing 3 is enhanced.

The distance W3 between the bridging portions 33 adjacent to each other is larger than a width W4 in the front-rear direction of the cell 21. In the present embodiment, for example, the distance W3 between the bridging portions 33 adjacent to each other is larger than twice the width W4, and two cells 21 are accommodated between the bridging portions 33 adjacent to each other. Thus, a separator function between the cells 21 is imparted to the casing 3, and the number of parts can be reduced.

A width W5 in the front-rear direction of the bridging portion 33 is smaller than a width W2 in the left-right direction of the side portion 32. Thus, it is possible to optimize the thickness of the side portion 32 and the bridging portion 33 according to the applied load, thereby achieving reduction in size, reduction in weight, and cost reduction of the casing 3.

The casing 3 configured as described above is made of aluminum, and is formed as an integrally molded product by extrusion molding. Specifically, the pair of end portions 31, the pair of side portions 32, and the pair of bridging portions 33 constituting the casing 3 are integrally formed by extrusion molding at the same time. In the extrusion molding, the width W1 in the front-rear direction of the end portion 31 is formed to be larger than the width W2 in the left-right direction of the side portion 32, and the width W5 in the front-rear direction of the bridging portion 33 is formed to be smaller than the width W2 in the left-right direction of the side portion 32.

As described above, according to the battery module 1 of the present embodiment, since the casing 3 surrounding the circumference of the cell stack body 2 receives the load in the cell stacking direction due to the expansion of the cell 21, the stress concentration can be alleviated.

In addition, since the width W1 in the front-rear direction of the end portion 31, that is, the thickness of the end portion 31 is larger than the width W2 in the left-right direction of the side portion 32, that is, the thickness of the side portion 32, even when the load in the cell stacking direction increases, the end portion 31 can receive the load.

Further, since the thickness of the side portion 32 is thinner than the thickness of the end portion 31, the size and weight of the battery module 1 can be reduced.

In addition, since the pair of end portions 32 is connected to each other by the bridging portions 33 extending in the left-right direction and the up-down direction, the rigidity of the side portion 32 and the entire casing 3 is enhanced.

In addition, since the width W5 in the front-rear direction of the bridging portion 33 is smaller than the width W2 in the left-right direction of the side portion 32, it is possible to optimize the thickness of the respective portions according to the applied load, thereby achieving reduction in size, reduction in weight, and cost reduction of the casing 3.

Further, since the casing 3 is the integrally molded product that is integrally formed, not only a process of assembling the casing 3 is not necessary, but also the stress concentration in the casing 3 can be alleviated.

In addition, since the casing 3 is made of aluminum and is formed by extrusion molding, not only the casing 3 can be easily manufactured, but also the weight of the casing 3 can be reduced.

In addition, since the external connection terminal 23 of the cell stack body 2 is fixed to the end portion 32 where the movement relative to the cell stack body 2 is regulated, the distance variation between the terminal 21a of the cell 21 and the external connection terminal 23 can also be regulated.

### Second Embodiment

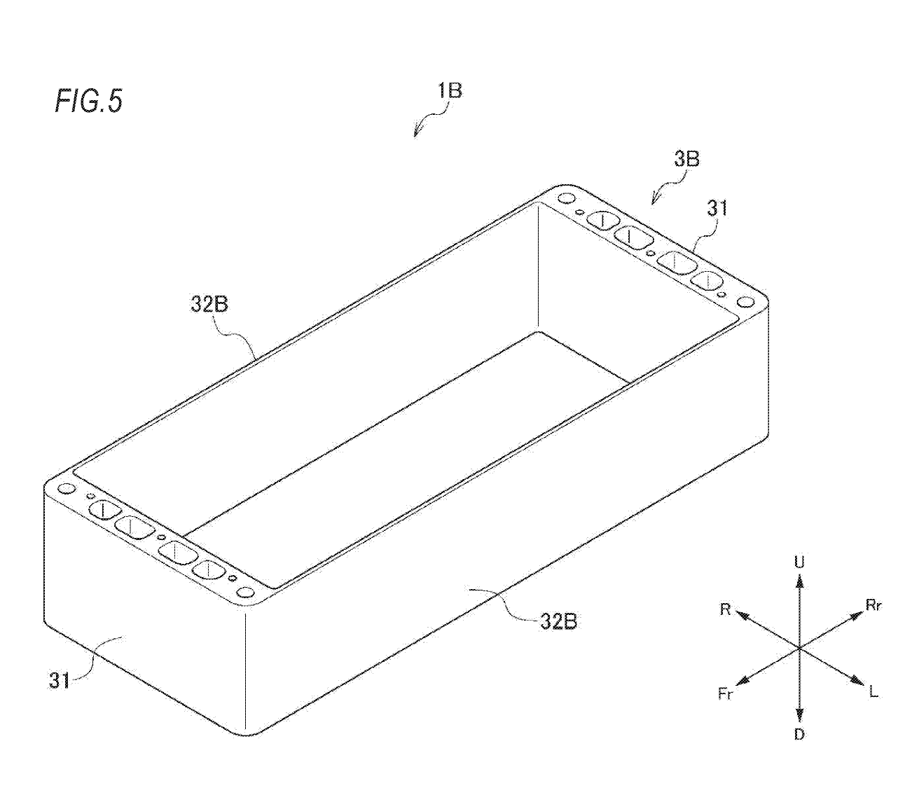

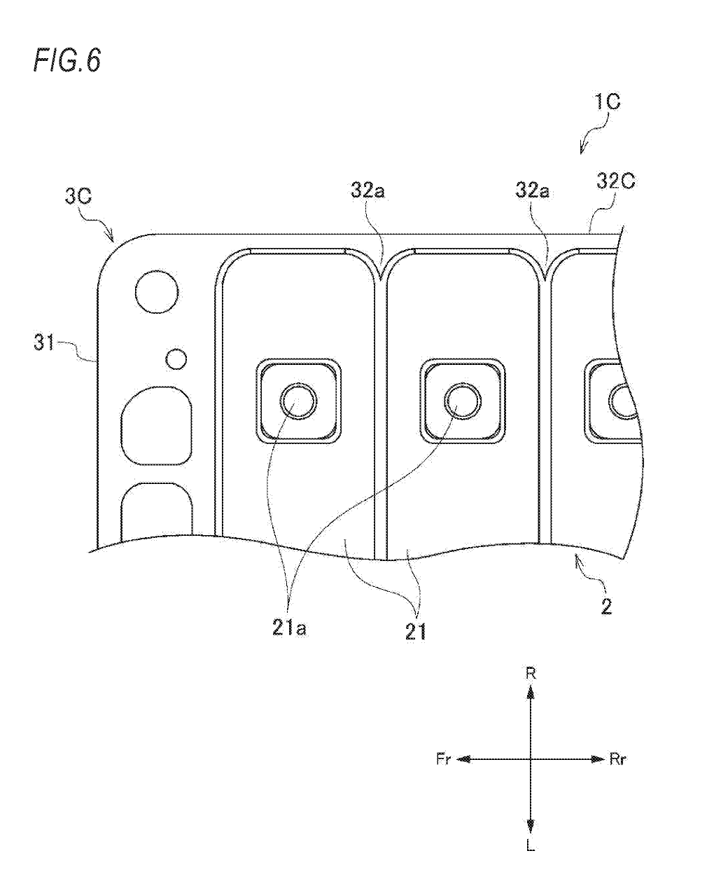

A battery module according to a second embodiment of the present invention will be described below with reference to FIGS. 5 and 6. However, only the differences from the first embodiment will be described, and the configurations common to the first embodiment will be denoted by the same reference numerals as in the first embodiment, so that the description of the first embodiment will be cited.

As illustrated in FIG. 5, a battery module 1B according to the second embodiment differs from that of the first embodiment in that bridging portions for connecting a pair of side portions 32B to each other are not formed in a casing 3B. In FIG. 5, the cell stack body 2 is not illustrated.

### Third Embodiment

As illustrated in FIG. 6, a battery module 1C according to a third embodiment differs from that of the first embodiment in that a side portion 32C of a casing 3C is provided with a plurality of projections 32a extending in an up-down direction between cells 21 adjacent to each other. For example, as illustrated in FIG. 6, the projection 32a has a shape conforming to a shape of a corner of the cells 21 adjacent to each other, and is engaged with the cell 21 in the front-rear direction. According to the battery module 1C of the third embodiment, vibration in the front-rear direction of the cell 21 can be prevented by the plurality of projections 32a provided in the side portion 32C. In addition, since the projection 32a can be formed simultaneously in extrusion molding, vibration in the front-rear direction of the cell 21 can be prevented without increasing the number of manufacturing steps.

It is noted that the present invention is not limited to the above-described embodiments, but can be appropriately modified and improved.

1. A battery module comprising:
a cell stack body that is constituted by a plurality of cells stacked in a front-rear direction and comprises a front surface, a rear surface, a left surface, a right surface, an upper surface, and a lower surface; and
a casing that accommodates the cell stack body, wherein
the casing comprises:
a pair of end portions extending along the front surface and the rear surface of the cell stack body; and
a pair of side portions extending along the left surface and the right surface of the cell stack body, and
a width in the front-rear direction of the end portion is larger than a width in a left-right direction of the side portion.

2. The battery module according to claim 1, wherein
the pair of side portions is connected to each other by a bridging portion extending in the left-right direction and an up-down direction.

3. The battery module according to claim 2, wherein
a width in the front-rear direction of the bridging portion is smaller than the width in the left-right direction of the side portion.

4. The battery module according to claim 1, Wherein
the pair of side portions each comprises a projection extending in an up-down direction between the cells adjacent to each other.

5. The battery module according to claim , wherein
the casing is an integrally molded product that is integrally formed.

6. The battery module according to claim 5, wherein
the casing is made of aluminum, and is formed by extrusion molding.

7. The battery module according to claim 1, wherein
the cell stack body comprises an external connection terminal, and
the external connection terminal is fixed to the end portion. cm 8. A method of manufacturing a battery module, wherein
the battery module comprises:
a cell stack body that is constituted by a plurality of cells stacked in a front-rear direction and comprises a front surface, a rear surface, a left surface, a right surface, an upper surface, and a lower surface and
a casing that accommodates the cell stack body, the casing is an integrally molded product which is integrally formed of aluminum, and includes:
a pair of end portions extending along the front surface and the rear surface of the cell stack body; and
a pair of side portions extending along the left surface and the right surface of the cell stack body, and
the method comprises forming the casing through extrusion molding such that a width in the front-rear direction of the end portion is larger than a width in a left-right direction of the side portion in the extrusion molding.

9. The method of manufacturing the battery module according to claim 8, wherein
the pair of side portions is connected to each other by a bridging portion extending in the left-right direction and an up-down direction, and
the bridging portion is also formed in the extrusion molding.

10. The method of manufacturing the battery module according to claim 9, wherein
in the extrusion molding, a width in the front-rear direction of the bridging portion is formed to be smaller than the width in the left-right direction of the side portion.

11. The method of manufacturing the battery module according to claim 8, wherein
the pair of side portions each comprises a projection extending in the up-down direction between the cells adjacent to each other, and
the projection is also formed in the extrusion molding.
